(19) United States
(12) Patent Application Publication
(10) Pub. No.: US 2008/0281758 A1
(43) Pub. Date: Nov. 13, 2008

(54) Postage value exchange system and method

(75) Inventor: Mark Ferraro, Hamden, CT (US)

Correspondence Address: Townsend and Townsend and Crew LLP, Two Embarcardero Center, San Francisco, CA, 94111-3834, US

(73) Assignee: Neopost Technologies

(21) Appl. No.: 11/797,976

(22) Filed: May 9, 2007

(51) Int. Cl. G06Q 50/00; H04L 9/32

(52) U.S. Cl. 705/60

(57) ABSTRACT

A postage value exchange system and method provides for the improved generation of postage indicators. A meter requesting device sends a meter request to a postage security device (PSD). The PSD processes the request based on the identification of the requesting device and a comparison of available metering funds. If authorized, the PSD provides a meter response that includes an authorization. Based on this authorization, the requesting device may thereupon locally generate the postage indicator, eliminating processing and transmission overhead from the PSD generating these indicators.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to postage metering and more specifically to the generation of postage value indicators from a postage value exchange and the reduction of data exchanged for generating a postage indicator.

Postal security devices (PSDs) allow a user to generate valid postage for mailing items without having to make a trip to the post office or use postal-generated stamps. These system have evolved, including the ability to load credit on the devices using secured connections and using these PSDs with various types of computing systems.

In existing postal systems, the user may request postage value from the PSD. In these systems, a user may use a stand-alone computing device to perform any number of functions and then subsequently request postage from the PSD. An example of a computing device may be a standard personal computer, where a user can type or formulate a piece of mail. When the mail is ready for printing, a secure connection with the PSD allows for the generation of postage information.

As dictated by the U.S. Postal System, there are numerous security requirements that must be followed when having a remotely accessed PSD. The PSD provides for the containment and distribution of U.S. Post Office funds since this credit in the device represents actual currency usable for sending mail.

There are several known techniques for accessing a PSD from a stand alone computing system, all of which require significant amount of processing overhead. For example, the technique described in U.S. Pat. No. 6,157,919 is a well known technique where postage authorization is requested from a PSD. The secure PSD, upon authentication of a postage request from a postage meter, thereby transmits back to the requesting device an identification that represents that postal image, where this identification is an indicia bit map. This indicia bit map represents an actual image that may be printed on the outside of the envelope and read by a postage metering system for processing, routing and authenticating postage payment.

This technique is very inefficient for numerous reasons. This technique requires the transmission of the postage identification, which have a significant size. Also, this technique requires that the PSD generate the image, which may be not be very efficient because the PSD typically has limited processing powers and is more aptly designed for regulating and securely distributing postage funds.

With the increase of computing power, there is also a direct increase in the capability for high speed printing and mass mailing applications. Where mail is printed and distributed in a large volume, it can be problematic using the inefficient existing PSD system. The requirements for the PSD to continually generate postage identifiers and then having to transmit this large amount of data can be a slow and time consuming process. It can cause significant delays in a high speed printing or a mass mailing environment.

### BRIEF DESCRIPTION OF THE DRAWINGS

FIG. 1 illustrates one embodiment of a postage value exchange system;

FIG. 2 illustrates a block diagram of one embodiment of a postage value exchange system;

FIG. 3 illustrates a graphical representation of a meter request;

FIG. 4 illustrates a graphical representation of a meter response; and

FIG. 5 illustrates a flowchart of the steps of one embodiment of a postage value exchange method.

### DETAILED DESCRIPTION

The postage value exchange system overcomes previous limitations by excluding the generation and transmission of postal image data between the postal security device (PSD) and the requesting device. Instead, the requesting device sends a postage request to an intermediate, herein referred to as a transfer function. The transfer function presents a meter request to the PSD, where this meter request includes information usable by the PSD to determine whether the request can be authenticated, i.e. if the requester has the funds to cover the requested postage amount.

The PSD thereby merely generates a meter response to the transfer function instead of generating and sending the postal image. The meter response includes information that allows the transfer function to thereby generate the postal image. Once the postal image is locally generated, the application program of the central computing system may thereupon print the postage indicia for mailing one or more mailing elements.

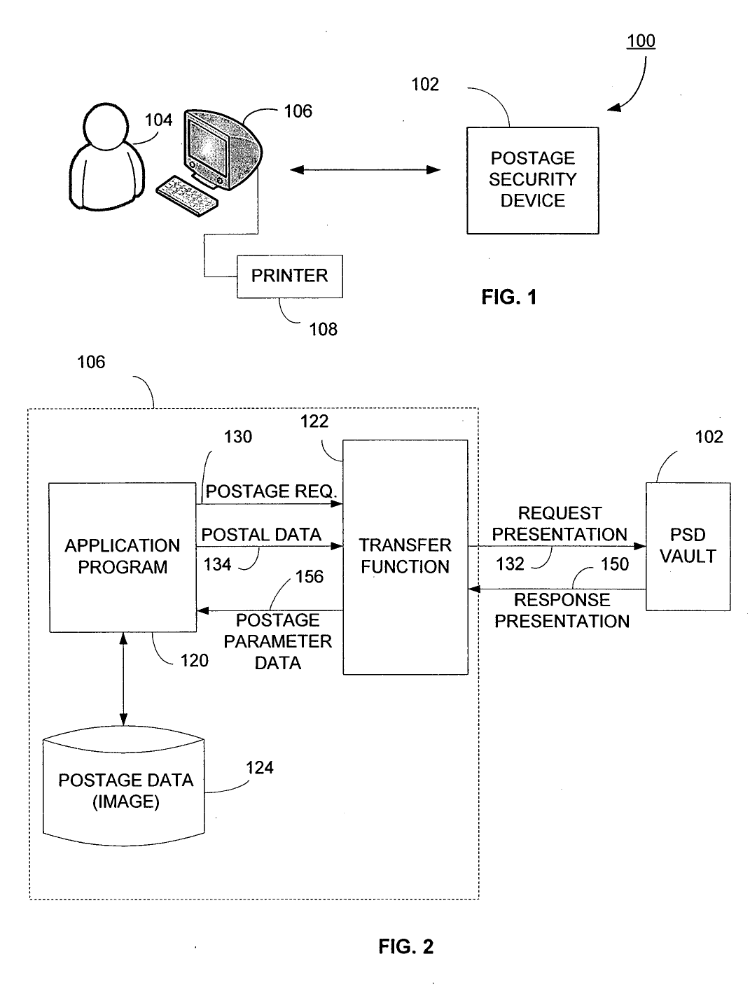

FIG. 1 illustrates one embodiment of a system 100 including a postage security device 102, a user 104, a computing device 106 and a printing device 108. The PSD may operate in accordance with known PSD technology, including the secure storage of postage values therein. As recognized by one skilled in the art, many components of the PSD have been omitted for clarity purposes only, such as components relating to the loading or reloading of value on the PSD, as well as additional security aspects utilized to insure the veracity of the data on the PSD itself as well as the veracity of the postage metering authorized by the PSD.

The computer 106 is illustrates as a standard personal computer device. This illustration is representative and not meant to be limiting, as the computer 106 may be any suitable computing device or system that allows for the requesting of postage. The computer 106 may include functionality for processing, viewing and/or editing the mailing elements. For example, the computer 106 may process batch files for mass mailing operations. In another example, the computer 106 include a word processing application where a user 104 wishes to print and mail a letter.

Additionally, the printing device 108 may any suitable printing device. For example, in one embodiment, the printer 108 may be a stand alone printer that prints a single document. In another embodiment, the printer 108 be a high speed printing device that prints a large volume of documents. It is also recognized that the printer 108 and the computing device 106 may be integrated into a single device, such as a high speed mailing device that includes the processing of mailing documents, the printing of postage as well as the stuffing of envelopes, by way of example.

In the system 100, the computer 106 interacts with the PSD 102 through any number of interconnections. For example, in one embodiment, the computer 106 and the PSD 102 may be locally disposed such as direct hardwired or internal networked connection. In another embodiment, the PSD 102 may be disposed in a central PSD bank where the computer 106 can securely access the PSD 102 over a secured network connection.

For discussion of the postage value exchange system of FIG. 1, FIG. 2 illustrates a block diagram of the computer 106 and the PSD 102. The computer 102 illustrated in FIG. 2 includes an application program 120, a transfer function device 122 and a postage data database 124. The application program 120 may be executed on one or more processing devices, in response to executable instructions. The application program 120 may include functionality for requesting postage metering for a mailing element. As described in further detail below, the postage request includes specific information usable by the PSD 102 for determining if funds are available.

The transfer function device 122, similar to the application program, 120, may be implemented in hardware, software or a combination thereof. The transfer function device 122 includes functionality, as described in further detail below, for coordinating between the PSD 102 and the application program 120. In this embodiment, the transfer function device 122 is illustrated as being within the computing device 106, but it is recognized that this device 122 may be disposed ancillary to the computing device 106 but in between the computing device 106 and the PSD 102.

The postage data database 124 may be one or more data storage locations operative to store postage image data therein. The postage data may include the image data usable by the application program for printing a postage indicator on an envelope or item to be mailed.

In one embodiment, the application program 120 may generate a meter request 130. The transfer function 122 receives the meter request 130 and in one embodiment transfers the meter request 130 to the PSD. The transfer function 122 may generate a request presentation 123 that includes additional information or data usable by the PSD 102, such as for example routing or security information.

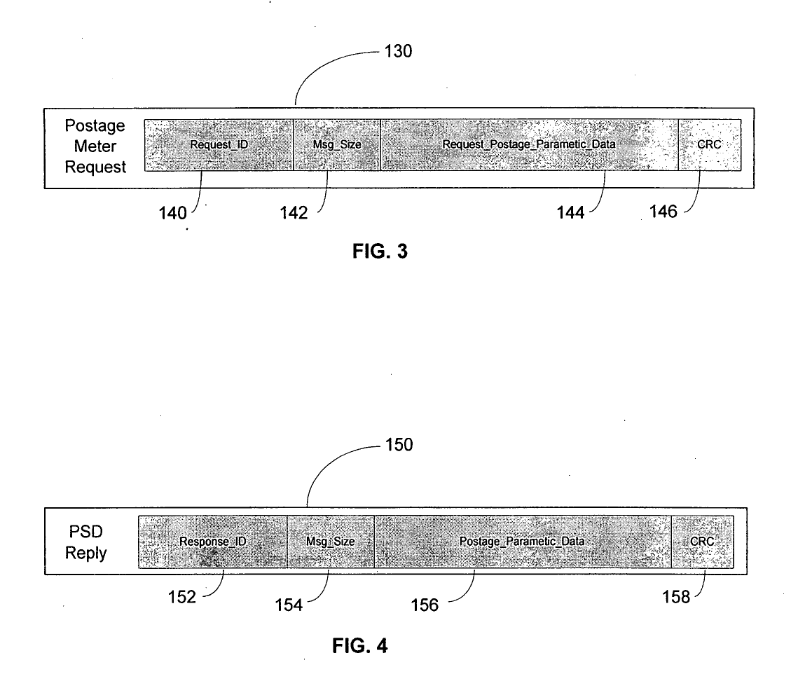

FIG. 3 illustrates a block diagram of a representative postage meter request 130 which includes four data fields. The first data field is a unique identifier 140 that indicates the requesting computer 106 or other identification information that identifies the requesting entity to the PSD 102. A second field 142 is a message size data field which is part of housekeeping information. A third field 144 is the meter request amount, which indicates the amount of postage being requested. A fourth data field 146 includes error correction codes, which are part of the housekeeping information.

Upon receipt of the meter request 130, the PSD 102 includes functionality for parsing out the information and applying the error correction codes 146, if needed. From the parsed information, PSD 102 is operative to determine which device is requesting postage information and what amount is being requested. The identity of the requesting entity allows for the determination of an account in the PSD 102, whereby standard accounting procedures may be used to determine if the PSD 102 can authorize the requested postage amount.

If the amount is authorized, the PSD 102 thereby simply generates a meter response that includes an indication of the authorization. In previous systems, the PSD would locally generate the image data, which is an inefficient procedure. Instead, the PSD 102 generates the meter response 150, where FIG. 4 illustrates a block diagram of one embodiment of the data of the meter response 150. The response 150 includes a unique identifier 152, which may the same unique identifier 140 of the meter request 130. The response 150 also includes a message size field 154 and error correction codes 158, which are part of the housekeeping data. Additionally, the response 150 includes an authorization amount 156. This amount 156 may be a standard meter value such as the meter amount requested. In another embodiment, this amount may be a yes or no indicator indicating authorization of the requested amount, where the response 150 thereby references the request 132, such as through the unique identifier 140 and/or 152 for tracking the request amount.

The transfer function 122 receives the meter response 150. The transfer function 150 thereby extracts the postage parameter data 156 and provides this data to the application program 120. The transfer function 122 may use the unique identifier 152 to monitor the incoming message 150 and may use the housekeeping data 154 and 158 to insure the correctness of the received information.

If the response 150 indicates authorization of the requested postage amount, the application program 120 thereupon generates the postage indicator using an image from the postage image database 124. This postage indicator may be any suitable image readable by a postage delivery system for facilitating the delivery of a metered mailing item.

The application program 120 may then include this postage image in the processing of metering items. For example, in the event that the postage is to be printed directly on a letter, the application program may update the letter with the postage indicator. In another example, if the postage indicator is to be printed on an envelope, the computing device 106 may coordinate with an envelope printer for printing the postage therein. In another example of a high speed printing machine, the computer 106 may coordinate the printing of postage, including the postage indicator, the printing of letters and the stuffing or preparing elements for mailing.

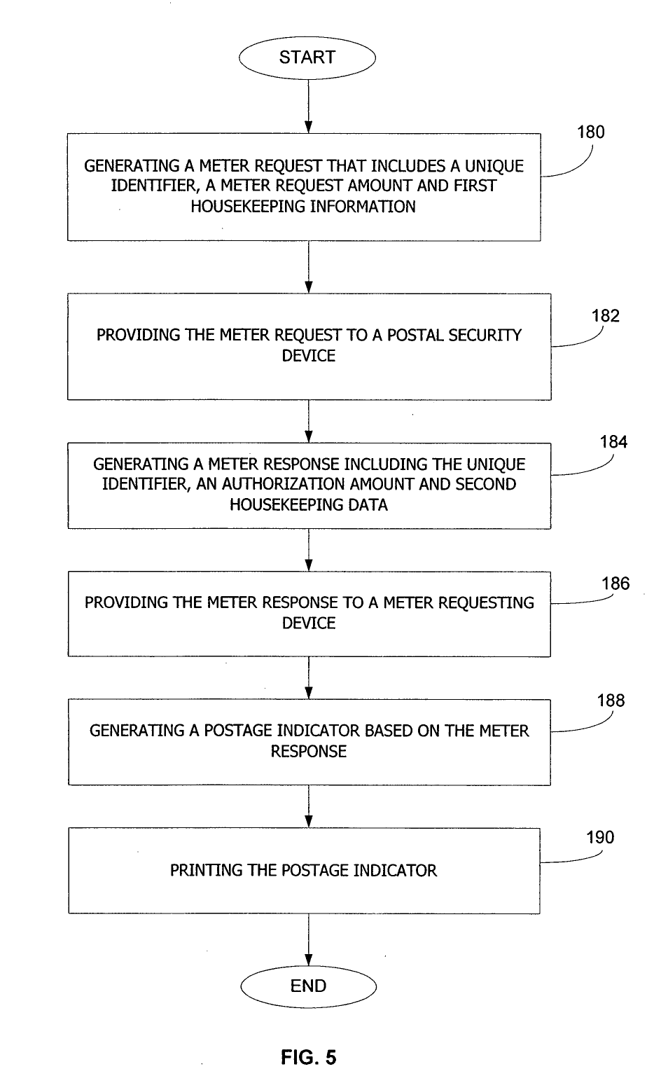

FIG. 5 illustrate steps of one embodiment of a postage value exchange method. This method may be performed by a computing device 106 and a PSD 102 as described above. In one embodiment, this method includes generating a meter request that includes a unique identifier, a meter request amount and first housekeeping information, step 180. Such as described above, this request 130 may be provided to a transfer function device 122 and includes the data fields 140-146 of FIG. 3.

In one embodiment, the next step, step 182, is providing the meter request to a postal security device. The transfer function device 122 may provide a request presentation 132 including the postage request therein to the PSD 102. This transmission may be across a local or remote network and may include security and/or encryption techniques for the postage request 130.

A next step, step 184, may be generating a meter response including the unique identifier, an authorization amount and second housekeeping data. Prior to this, the PSD 102 may also perform authorization procedures which may include reviewing the data in the postage meter request and determining if the requester has sufficient funds to cover the requested amount. This may be done by a review of the comparison identifier 140 and then using a look-up table or other type of reference to compare the available funds with the requested amount. The generation of the meter response provides the results of this authorization back to the requesting device. Therefore, the meter response 150 includes the unique identifier 152, the authorization amount 156 and the housekeeping data 154 and 158.

In one embodiment, the next step, step 186, is providing the meter response to the meter requesting device. This may include the response 150 being received by the computing device 106. In one embodiment, the transfer function device 122 extracts the postage parameter data 156 and provides this data directly to the application program 120. A next step, step 188, is generating a postage indicator based on the meter response. As described above, the postage indicator may be generated based on retrieving or using a locally-stored image and generating the postage indicator using this locally-stored image in conjunction with the PSD authorization.

The requesting device 106 may be associated with a mailing system or with any other type of computing system, therefore an additional step, step 190, may be printing the postage indicator. This step may be performed locally by the requesting device 106, but may also be performed remotely in the event the processing device 106 processes the mailing information and thereupon provides printable information to ancillary or dedicated printing system.

Through the above-described system and technique, the generation of postage indicators for mailing applications are greatly improved. The utilization of authorization from a PSD obviates the transmission requirements for generating and sending data intensive and bandwidth intensive images. Instead, based on the authorization, these images are generated relative to the requesting device.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An postage value exchange system comprising:
a meter requesting device;
a postal security device in operative communication with the meter requesting device;
the meter requesting device generating a meter request that includes a unique identifier, a meter request amount and first housekeeping information, where the meter request is received by the postal security device;
the postal security device generating a meter response including the unique identifier, an authorization amount and second housekeeping data, where the meter response is received by the meter requesting device;
the meter requesting device operative to generate a postage indicator based on the meter response; and
a printing device for printing the postage indicator.

2. The postage value exchange system of claim 1 wherein the meter requesting device is a personal computer.

3. The postage value exchange system of claim 1 wherein the meter response only includes the unique identifier, the authorization amount and the second housekeeping data.

4. The postage value exchange system of claim 1 wherein the authorization amount equals the meter request amount when the postal security device includes sufficient funds to cover the meter request amount.

5. The postage value exchange system of claim 1 further comprising:
a transfer function device disposed between the meter requesting device and the postal security device, the transfer function device operative to facilitate transfer of meter request and meter response therebetween.

6. A postage value exchange method comprising:
generating a meter request that includes a unique identifier, a meter request amount and first housekeeping information
providing the meter request to a postal security device;
generating a meter response including the unique identifier, an authorization amount and second housekeeping data;
providing the meter response to a meter requesting device;
generating a postage indicator based on the meter response; and
printing the postage indicator.

7. The postage value exchange method of claim 6 wherein the meter requesting device is a personal computer.

8. The postage value exchange method of claim 6 wherein the meter response only includes the unique identifier, the authorization amount and the second housekeeping data.

9. The postage value exchange method of claim 6 wherein the authorization amount equals the meter request amount when the postal security device includes sufficient funds to cover the meter request amount.

10. The postage value exchange method of claim 6 further comprising:
facilitating transfer between the meter requesting device and the postal security device using a transfer function device disposed therebetween.

11. A computer comprising:
an application executable on a processing device for processing a mailing element, the application generating a meter request;
a transfer function device coupled to a postal security device, the transfer function device operative to provide the meter request thereto, where the meter request includes a unique identifier, a meter request amount and first housekeeping information;
a postage data storage device coupled to the transfer function device;
wherein the transfer function device is operative to receive a meter response that includes the unique identifier, an authorization amount and second housekeeping information such that when the authorization amount is equal to or greater then the meter request amount, the transfer function retrieves a postage identification information for generating a postal image that is usable with the mailing element.

12. The computer of claim 11 further comprising:
a printing device coupled to the processing device such that the printing device is operative to, in response to printing commands, print the postal image.

13. The computer of claim 11 wherein the meter response only includes the unique identifier, the authorization amount and the second housekeeping data.
